(19) United States
(12) Patent Application Publication
(10) Pub. No.: US 2002/0197364 A1
(43) Pub. Date: Dec. 26, 2002

(54) Producing liquid products contained in cans, bottles and other suitable containers

(76) Inventor: Christopher Chia Shyong Pan, West Footscray, Vic (AU)

Correspondence Address: Killworth, Gottman,, Hagan & Schaeff, L.L.P., One Dayton Centre, Suite 500, Dayton, OH, 45402-2023, US

(21) Appl. No.: 10/233,860

(22) Filed: Sep. 3, 2002

Related U.S. Application Data
(63) Continuation of application No. 09/462,338, filed on Jul. 3, 2000.

(30) Foreign Application Priority Data
Jul. 10, 1997 (AU) PO7803
May 28, 1998 (AU) PP3750

(51) Int. Cl. A23C 1/00

(52) U.S. Cl. 426/316

(57) ABSTRACT

A method of producing a liquid product packed in cans or bottles or other suitable containers is disclosed. The method includes injecting one or more of nitrogen, carbon dioxide and nitrous oxide gas into the liquid product. One preferred feature of the method is to chill the liquid product prior to injecting gas. Another preferred feature is to add liquid nitrogen to the head spaces of filled containers before closing the containers. A liquid product which includes nitrogen, carbon dioxide and nitrous oxide is also disclosed.

The present invention relates to a method of producing a liquid product packed in cans or bottles or any other suitable container.

The present invention relates particularly, although by no means exclusively, to a method of producing a carbonated beverage product, such as beer, packed in cans or bottles or any other suitable container.

One particular, although by no means exclusive, application of the present invention is a method of producing beer in cans or bottles or any other suitable containers which has a smooth, non-bitter, taste and excellent foaming characteristics and the following discussion of the prior art is in this context.

Australian patent application 55602/86 entitled “Carbonating in Bottles and Cans” in the name of Gatehouse Technical Ventures Limited describes that foam is an important element in the consumer appeal of most beers and of some other carbonated beverages. More particularly, the Gatehouse patent application describes that:

“The most important means by which foam is produced by any of these liquids is the release of carbon dioxide from super-saturated solution. Super-saturation arises when a previously-closed, pressurised container is opened to atmosphere or when the liquid contents are discharged from within it through a tap or similar device. Bubbles of carbon dioxide gas are then released by turbulent flow, by nucleation on solid surfaces or particles, or by diffusion into existing gas bubbles.

In the case of beers and other carbonated beverages, bubbles aggregate to produce foam which rests on top of the beverage in the drinking-glass (or other drinking container). More bubbles are released, and foam consequently produced, as the beverage is drawn into and flows within the mouth, producing a variety of sensory impressions including viscosity. As the beverage is tipped from the glass, foam clings to its walls, giving an attractive pattern known as ‘lacing’.”

It is known that carbonation causes beer to have carbon dioxide bite and, whilst this taste is regarded favourably by some sections of the consumer market, there are other sections of the market that regard the taste as undesirable.

It is known to add nitrogen to beer as an alternative means of producing foam in beer. It is also known that nitrogen causes beer to have a smoother, less bitter, taste.

There are a number of known options for introducing nitrogen into beer.

One option is to dissolve nitrogen in beer prior to filling into cans or bottles. This option is described in a number of patent applications and patents including, by way of example, Australian patents 642219 and 642714 in the name of The BOC Group plc and International application PCT/SE95/01449 (WO 96/17529) in the name of Tetra Laval Holdings & Finance S A. In each of these patents and patent application, the main reason for adding nitrogen gas to cans is to generate super-atmospheric pressure in the head-spaces of the cans to prevent deformation of the cans during normal handling of the cans.

The addition of nitrogen gas to non-carbonated liquid products prior to filling into cans or bottles is also described in a number of patents and patent applications including, by way of example, Australian patent 642789 in the name of The BOC Group plc, UK patent application 2134496 in the name of Asahi Breweries Ltd, and U.S. Pat. No. 4,347,695 in the name of General Foods Corporation.

The Gatehouse patent application describes the option of dissolving nitrogen in beer prior to filling into cans or bottles in the following negative terms:

“if nitrogen is dissolved in the beverage in a reservoir before a filling operation carried out in currently used equipment for filling small containers with carbonated beverages, most of the nitrogen is removed by ‘gas washing’ because, due to the much lower solubility of nitrogen than carbon dioxide in the liquid, any bubbles liberated by liquid movement entrain nitrogen.”

Another option for introducing nitrogen into beer is to add nitrogen to beer at a filling station.

The Gatehouse patent application describes as an invention a method of producing cans and bottles containing beer in accordance with this option which comprises the steps of:

(i) partially filling a can or bottle with a predetermined quantity of beer;

(ii) adding a predetermined quantity of liquid nitrogen to the container or bottle; and

(iii) sealing the can or bottle.

The Gatehouse patent application describes that the addition of nitrogen to beer in amounts of up to 1.14 grams of liquid nitrogen per liter of beer was found to progressively improve foaming properties of beer.

A further option for introducing nitrogen into beer is by means of inserts, commonly referred to as “widgets”, that are positioned in cans and store nitrogen gas when the cans are sealed and release the gas as small bubbles when the cans are subsequently opened. The small bubbles produce foam in the beer. The cost of the widgets and difficulties locating the widgets in cans in a high throughput commercial line have limited the use of the widgets.

A particular objective of the present invention is to provide an improved method of producing cans or bottles or other suitable containers containing beer.

A more general objective of the present invention is to provide an improved method of producing cans or bottles or other suitable containers containing a carbonated or a non-carbonated liquid product.

According to one aspect of the present invention there is provided a method of producing a liquid product packed in cans or bottles or other suitable containers which includes:

(i) injecting nitrous oxide and one or more than one of nitrogen and carbon dioxide into the liquid product;

(ii) pressurising the liquid product to increase the solubility of nitrous oxide and one or more than one of nitrogen and carbon dioxide in the liquid product; and

(iii) filling the liquid product into cans or bottles or other suitable containers and thereafter sealing the cans or bottles or other suitable containers.

The cans or bottles or other suitable containers may be made from any suitable material. By way of example, suitable materials include, metal, glass and PET.

In one embodiment the method further includes depressurising the liquid product of step (ii) prior to filling the liquid product into cans or bottles or other suitable containers in step (iii).

In another embodiment the method further includes partially depressurising the liquid product of step (ii) prior to filling the liquid product under the reduced pressure into cans or bottles or other suitable containers in step (iii).

In one embodiment the method includes chilling the liquid product to a predetermined temperature prior to step (i) of injecting nitrous oxide and one or more than one of nitrogen and carbon dioxide into the chilled liquid product.

In another embodiment the method includes chilling the liquid product to a predetermined temperature after step (i) of injecting nitrous oxide and one or more than one of nitrogen and carbon dioxide into the liquid product.

Preferably the predetermined temperature is in the range of −1° C.-8° C.

More preferably the temperature range is −1° C.-4° C.

It is preferred particularly that the temperature range be −1° C.-1° C.

Preferably step (i) of injecting nitrous oxide and one or more than one of nitrogen and carbon dioxide into the liquid product in step (i) is carried out under pressure.

Preferably the pressure is at least 2 atmospheres absolute.

Any suitable combination of nitrous oxide and one or more than one of nitrogen and carbon dioxide, may be injected into the liquid product in step (i).

Specifically: nitrous oxide and nitrogen; nitrous oxide and carbon dioxide; and nitrous oxide, nitrogen and carbon dioxide; may be injected in step (i).

In a situation where the liquid product is beer, it is preferred that each of nitrogen, carbon dioxide, and nitrous oxide be injected in step (i) into the beer.

In one embodiment the nitrous oxide, nitrogen and carbon dioxide are injected as gases.

The nitrogen, carbon dioxide and nitrous oxide may be injected into the liquid product as a gas mixture or as separate gases.

In another embodiment the nitrous oxide and carbon dioxide are injected as gases and the nitrogen is injected as a liquid.

Preferably, the liquid product supplied to step (i) is a carbonated liquid product. Depending on the concentration of carbon dioxide, the method may include stripping excess carbon dioxide from the liquid product prior to step (i).

Preferably the liquid product is pressurised to at least 2 atmosphere absolute in step (ii).

More preferably the liquid product is pressurised to at least 5 atmosphere absolute in step (ii).

It is preferred particularly that the liquid product be pressurised to 7-8 atmosphere absolute in step (ii).

Preferably the liquid product is held under pressure in step (ii) for at least 2 minutes.

Preferably the liquid product is held under pressure in step (ii) for less than 10 minutes.

In a situation where the liquid product is beer, the nitrogen is added principally to generate small bubbles which produce foam when sealed cans or bottles are opened.

The carbon dioxide and nitrous oxide are more soluble than nitrogen and therefore are not as effective as nitrogen in generating foam—although a portion of both gases will contribute to producing foam when the cans or bottles are opened.

The principal purpose of adding carbon dioxide to beer is to ensure that beer does not go “flat” shortly after being poured from the can or bottle into a glass or other container.

The principal purpose of nitrous oxide is to take away the adverse effect of carbon bite caused by carbon dioxide.

In addition to the above, each of nitrogen, carbon dioxide and nitrous oxide contributes to producing a super atmospheric pressure in the head spaces of the cans or bottles or other suitable containers to withstand deformation during normal handling of the sealed cans or bottles or other suitable containers.

Preferably the method further includes injecting liquid nitrogen into the head spaces of the cans or bottles or other suitable containers after filling the cans or bottles or other suitable containers with the liquid product and prior to sealing the cans or bottles or other suitable containers.

According to the present invention there is also provided a liquid product contained under pressure in a sealed can or bottle or other suitable container, which liquid product includes nitrogen, carbon dioxide, and nitrous oxide which are released as gaseous phases and cause foaming of the liquid product when the can or bottle or other suitable container is opened.

The applicant has carried out a series of experiments/trials producing and thereafter testing liquid products, such as beer, in sealed cans—as described in the preceding paragraph. The applicant found that the cans of liquid products exhibited excellent foaming characteristics and taste. The applicant also found in a number of instances that the foaming characteristics were enhanced by shaking the cans prior to opening the cans and pouring out the liquid products. This is a surprising result in relation to carbonated liquid products, such as beer, because usually even minor amounts of shaking generate excessive amounts of foaming and are undesirable on this basis.

Preferably the sealed can or bottle or other suitable container contains 0.01-4 volume of nitrous oxide per unit volume of the liquid product.

More preferably the sealed can or bottle or other suitable container contains 0.3-1.2 volumes of nitrous oxide per unit volume of the liquid product.

More preferably the sealed can or bottle or other suitable container contains 0.4-1.2 volumes of nitrous oxide per unit volume of the liquid product.

Preferably the sealed can or bottle or other suitable container contains 0.1-3.5 volume of carbon dioxide per unit volume of the liquid product.

More preferably the sealed can or bottle or other suitable container contains 0.5-2.6 volumes of carbon dioxide per unit volume of the liquid product.

More preferably the sealed can or bottle or other suitable container contains 0.9-1.5 volumes of carbon dioxide per unit volume of liquid product.

It is preferred particularly that the sealed can or bottle or other suitable container contains 1.2-1.5 volumes of carbon dioxide per unit volume of liquid product.

Preferably the sealed can or bottle or other suitable container contains 0.1-1.8 volume of nitrogen per unit volume of the liquid product.

More preferably the sealed can or bottle or other suitable container contains 0.5-1.2 volumes of nitrogen per unit volume of the liquid product.

More preferably the sealed can or bottle or other suitable container contains 0.8-1.2 volumes of nitrogen per unit volume of the liquid product.

It is preferred particularly that the sealed can or bottle or other suitable container contains 1-1.2 volumes of nitrogen per unit volume of the liquid product.

Preferably the internal pressure of the sealed bottle or container is greater than 3 atmosphere absolute at ambient temperature.

More preferably the internal pressure is 4-5 atmospheres absolute.

Preferably the sealed can or bottle or other suitable container does not include a “widget” or other device for storing nitrogen, carbon dioxide and nitrous oxide for release when the can or bottle is opened.

Preferably the liquid product is beer.

According to another aspect of the present invention there is also provided a method of producing a carbonated liquid product, such as beer, packed in cans or bottles or other suitable containers which includes:

(i) placing a predetermined quantity of a carbonated liquid product in the cans or bottles or other suitable containers;

(ii) adding nitrogen, and optionally one or more other additives which promote foaming, to the liquid product in the cans or bottles or other suitable containers; and

(iii) sealing the cans or bottles or other suitable containers.

It is preferred that the nitrogen be added as liquid nitrogen.

Preferably nitrous oxide is added as a foaming agent.

Preferably, when the nitrogen and carbon dioxide are the only foaming agents in the liquid product, the nitrogen is added to step (ii) in an amount of more than 1.14 grams of nitrogen per liter of the liquid product.

According to another aspect of the present invention there is also provided a method of producing a carbonated liquid product, such as beer, packed in cans or bottles or other suitable containers, which includes:

(i) dissolving nitrogen, and optionally one or more other additives which promote foaming, into a carbonated liquid product to form a nitrogen-containing liquid product;

(ii) filling a can or bottle or other suitable container with a predetermined quantity of the nitrogen-containing liquid product; and

(iii) sealing the can or bottle or other suitable container.

It is preferred that the nitrogen be added as a gas.

Preferably nitrous oxide is added as a foaming agent.

Preferably the method includes chilling the carbonated liquid product prior to dissolving nitrogen in step (i).

Preferably, when nitrogen carbon dioxide are the only foaming agents in the liquid product, the nitrogen is added in an amount of more than 1.14 grams of nitrogen per liter of li1quid product.

The applicant has found that the addition of nitrogen to beer that contains less than the conventional level of carbonation in amounts greater than 1.14 grams of nitrogen per liter of beer increases significantly the foaming characteristics of the beer and causes the beer to have a smoother, less bitter, taste compared to beer having no nitrogen addition, the conventional level of carbonation, and no other foaming agents.

It is preferred that the liquid product be beer although it is emphasised that the invention is not restricted to beer and extends to any other liquid product and to any non-carbonated liquid product.

The term “foaming agent” is understood to mean any agent, in gaseous or liquid form, that promotes foaming in a liquid product.

The term “foaming agent” includes, by way of example only, nitrogen, carbon dioxide, nitrous oxide, and argon.

Where the liquid product contains foaming agents in addition to nitrogen and carbon dioxide, the amount of the nitrogen added to the liquid product may be less than 1.14 grams per liter of the liquid product with the amount of the nitrogen depending on the amount and foaming properties of the other foaming agent(s) added to the liquid product.

In one embodiment the beer and the cans or bottles or other suitable containers are separately sterilised and transferred under sterile conditions to a filling station maintained under sterile conditions. At the filling station, measured quantities of beer are filled into the cans and bottles or other suitable containers, thereafter an amount of liquid nitrogen, preferably greater than 1.14 grams per liter of beer, is added to the cans and bottles or other suitable containers, and finally the cans and bottles or other suitable containers are sealed.

A particular advantage of this embodiment is that the sterilisation of the beer and the cans and bottles or other suitable containers involves no increase in the internal pressure of the canned and bottled beer.

Alternatively the beer and the cans or bottles or other suitable containers are transferred under non-sterilised conditions to a filling station, measured quantities of the beer are filled into the cans or bottles or other suitable containers, thereafter an amount of liquid nitrogen, preferably greater than 1.14 grams per liter of beer, is added, and the cans or bottles or other suitable containers are then sealed. Finally, in order to pasteurise or sterilise the canned and bottled beer, the cans and bottles or other suitable containers are exposed to various means of heating. The heating of the beer produces an increase in internal pressure. In order to accommodate the pressure increase it is necessary to use stronger cans or bottles or other suitable containers than are used conventionally and/or to provide a larger head space than is used conventionally for a given volume of beer to allow for volume expansion.

The present invention is described further by way of example with reference to the accompanying drawings, of which:

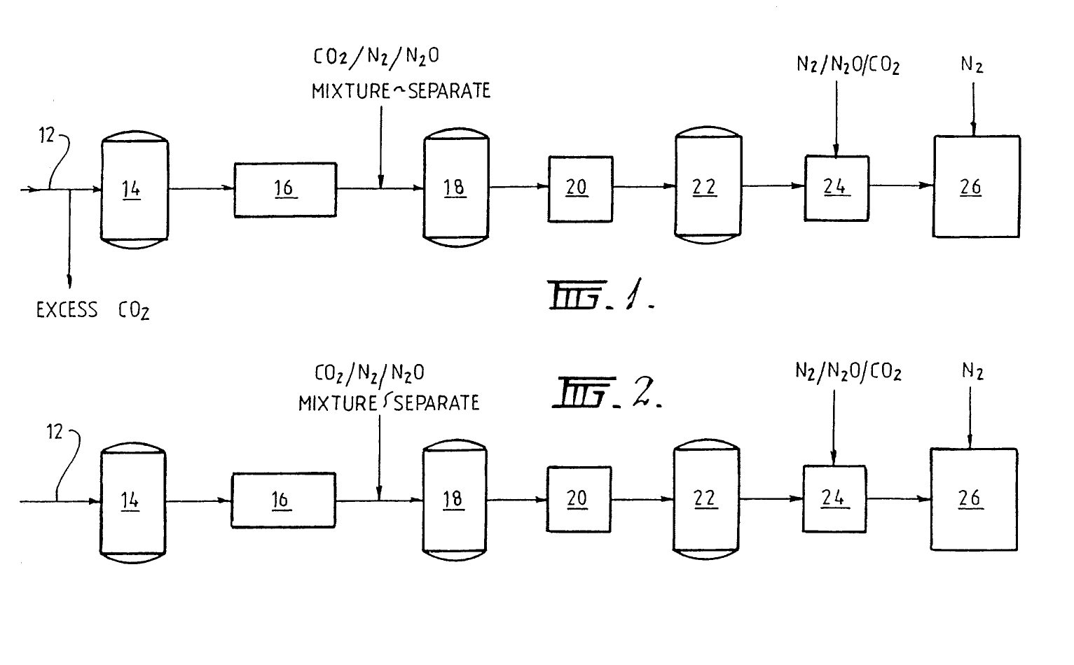

FIG. 1 is one preferred embodiment of a method of producing canned or bottled beer in accordance with the present invention;

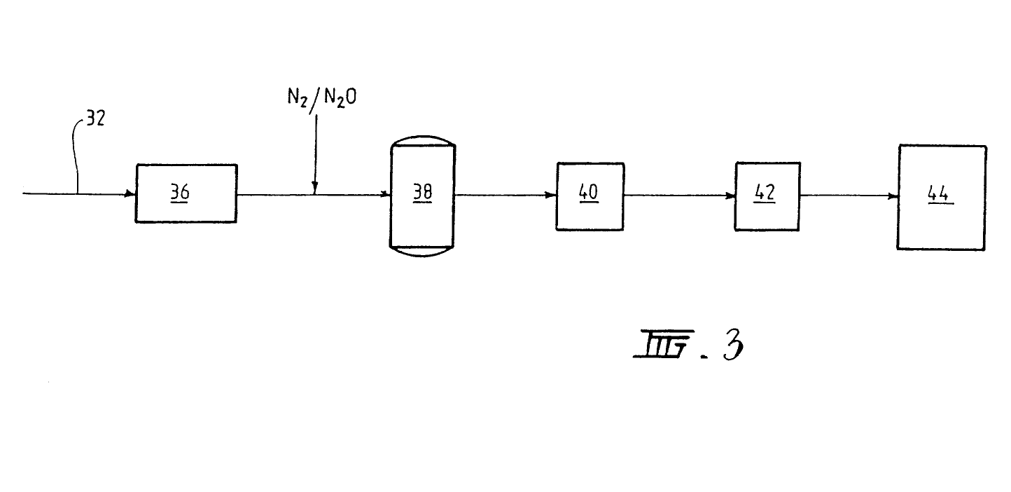

FIG. 2 is another preferred embodiment of a method of producing canned or bottled beer in accordance with the present invention; and

FIG. 3 is another preferred embodiment of a method of producing canned or bottled beer in accordance with the present invention.

The preferred embodiments described below relate to producing beer. It is emphasised that the present invention is not limited to producing beer and extends to producing any carbonated and non-carbonated liquid product.

With reference to FIG. 1, carbonated beer produced by conventional beer-making technology flows along a line 12 and excess carbon dioxide (if any) is stripped from the beer prior to the beer reaching the holding tank 14.

The beer flows from the holding tank 14 through a chiller 16 in which the beer is chilled to a temperature in a range of −1° C. to 4° C.

Thereafter, any one or more of nitrogen gas, carbon dioxide gas, and nitrous oxide gas are injected under pressure of 2-3 atmospheres absolute into the chilled beer as it flows from the chiller 16 to a holding tank 18.

The gases may be injected separately or as a gas mixture.

It is preferred that a mixture of nitrogen, carbon dioxide, and nitrous oxide gases be injected in the chilled beer.

The amount of each gas injected into the chilled beer should be within the broad range described above and having regard to the levels of injection of the other gases. As a general guideline, as the level of injected carbon dioxide increases, the level of injected nitrous oxide can decrease.

The beer flows from the holding tank 18 to a pressurisation station 20 at which the beer is pressurised to at least 7 atmosphere absolute to increase the dissolution of the injected gases into the beer.

The pressurised beer flows to a holding tank 22 and thereafter to a depressurisation station 24 at which the pressure is reduced to atmospheric pressure or any other suitable filling pressure and the beer is then filled into cans at a filling station 26.

The pressurisation station 20 and the depressurisation station 24 may be of any suitable construction. Typically, the stations are tank or pipes. The stations may be a single vessel.

The embodiment of the method shown in FIG. 2 is similar to that shown in FIG. 1. The main difference is that the beer supplied to the method is not carbonated. As a consequence, injection of carbon dioxide gas after the chiller 16 is necessary to produce required levels of carbon dioxide.

With reference to FIG. 3, carbonated beer produced by conventional beer-making technology flows along a line 32 to a chiller 36 and is cooled in the chiller to a temperature in the range of −1° C. to 4° C.

The chilled beer flows from the chiller 36 to a holding tank 38 and a gas mixture of nitrogen and nitrous oxide, and optionally carbon dioxide, is injected into the beer under pressure of 2-3 atmospheres absolute before it reaches the holding tank 36.

The beer flows from the holding tank 38 to a pressurisation station 40 at which the beer is pressurised to 7-8 atmospheres absolute.

The method may include the optional steps of passing the beer from the holding tank 38 through a second chiller (not shown) to adjust the temperature of the beer and injecting further nitrogen gas to the beer to reach a required level of nitrogen in the beer before supplying the beer to the pressurisation station 40.

The beer flows from the pressurisation station 40 to a depressurisation station 42 at which the beer is depressurised to 3-5 atmospheres absolute.

The beer is then filled at a filling station 44 into cans or bottles or other suitable containers under this pressure and liquid nitrogen is added to the head space of each container prior to closing the containers.

The applicant has carried out a series of trials of the preferred embodiment shown in FIG. 3 on a commercial filling line. The trials were successful and produced canned beer with foaming characteristics that were at least comparable to “widget” containing cans.

The method includes an option of providing nitrogen gas, carbon dioxide gas, and nitrous oxide gas at the depressurisation station 24 to maintain the levels of these gases in the beer. Specifically, in a situation where the depressurisation station includes a tank with a head space, it is important to maintain the partial pressure of nitrogen, carbon dioxide, and nitrous oxide in the head space the same as the required partial pressure of these gases in the beer.

In addition, the method includes an option of introducing liquid nitrogen into the head space of cans or bottles prior to sealing the cans or bottles.

Many modifications may be made to the preferred embodiments described above without departing from the spirit and scope of the present invention.

By way of example, whilst each preferred embodiment chills the beer prior to injecting one or more of nitrogen, carbon dioxide, and nitrous oxide into the beer, the present invention is not limited to this arrangement and gas injection can be made prior to chilling the beer. Chilling the beer prior to gas injection is particularly preferred for a range of reasons, including avoiding the possibility of icing up of the chiller.

By way of further example, whilst each preferred embodiment includes separate holding tanks and pressurisation/depressurisation stations, the present invention is not limited to this arrangement and extends to any suitable arrangement. By way of example, a single tank could be used in place of the holding tanks and the pressurisation/depressurisation stations.

1. A method of producing a liquid product packed in cans or bottles or other suitable containers which including the steps of:
(i) injecting nitrous oxide and one or more than one of nitrogen and carbon dioxide into the liquid product;
(ii) pressurising the liquid product to increase the solubility of nitrous oxide and one or more than one of nitrogen and carbon dioxide in the liquid product; and
(iii) filling the liquid product into cans or bottles or other suitable containers and thereafter sealing the cans or bottles or other suitable containers.

2. The method defined in claim 1 further including the step of at least partially depressurising the liquid product of step (ii) prior to filling the liquid product into cans or bottles or other suitable containers in step (iii).

3. The method defined in claim 1 including the step of chilling the liquid product to a predetermined temperature prior to or after step (i).

4. The method defined in claim 3 wherein the predetermined temperature in ste p (i) is in the range of −1° C.-8° C.

5. The method defined in claim 3 wherein the temperature range is −1° C.-4° C.

6. The method defined in claim 3 wherein the temperature range is −1° C.-1° C.

7. The method defined in claim 1 wherein the step of injecting nitrous oxide and one or more than one of nitrogen and carbon dioxide into the liquid product is carried out under pressure.

8. The method defined in claim 7 wherein the pressure is at least 2 atmospheres absolute.

9. The method defined in claim 1 wherein step (i) includes injecting each of nitrogen, carbon dioxide, and nitrous oxide into the liquid product.

10. The method defined in claim 9 wherein the nitrogen, carbon dioxide and nitrous oxide are injected as gases.

11. The method defined in claim 10 wherein the nitrogen, carbon dioxide and nitrous oxide are injected into the liquid product as a gas mixture.

12. The method defined in claim 10 wherein the nitrogen, carbon dioxide and nitrous oxide are injected to the liquid product as separate gas es.

13. The method defined in claim 1 wherein step (i) includes injecting nitrous oxide and nitrogen into the liquid product.

14. The method defined in claim 13 wherein the nitrous oxide and nitrogen are injected into the liquid product as a gas mixture.

15. The method defined in claim 13 wherein the nitrous oxide and carbon dioxide are injected into the liquid product as separate gases.

16. The method defined in claim 1 wherein step (i) includes injecting nitrous oxide and carbon dioxide into the l iquid product.

17. The method defined in claim 16 wherein the nitrous oxide and carbon dioxide are injected into the liquid product as a gas mixture.

18. The method defined in claim 16 wherein the nitrous oxide and carbon dioxide are injected as separate gases.

19. The method defined in claim 1 wherein the liquid product is a carbonated liquid product and the method includes stripping excess carbon dioxide from the liquid product prior to step (i).

20. The method defined in claim 1 wherein the liqui d product is pressurised to at least 2 bar absolute in step (ii).

21. The method defined in claim 20 wherein the liquid product is pressurised to at least 5 atmosphere absolute in step (ii).

22. The method defined in claim 21 wherein the liquid product is pressurised to 7-8 atmosphere absolute in step (ii).

23. The method defined in claim 1 wherein the liquid product is held under pressure in step (ii) for at least 2 minutes.

24. The method defined in claim 23 wherein the liquid product is held unde r pressure in step (ii) for less than 10 minutes.

25. The method defined in claim 1 further including the step of injecting liquid nitrogen into the head spaces of the cans or bottles or other suitable containers after filling the cans or bottles or other suitable containers with the liquid product and prior to sealing the cans or bottles or other suitable containers.

26. A liquid product contained under pressure in a sealed can or bottle or other suitable container, which liquid product includes nitrog en, carbon dioxide, and nitrous oxide which are released as gaseous phases and cause foaming of the liquid product when the can or bottle or other suitable container is opened.

27. The container defined in claim 26 containing 0.1-3.5 volumes of carbon dioxide per unit volume of the liquid product.

28. The container defined in claim 27 containing 0.9-1.5 volumes of carbon dioxide per unit volume of liquid product.

29. The container defined in claim 28 containing 1.2-1.5 volumes of carbon dioxide per unit volume of liquid product.

30. The container defined in claim 26 containing 0.1-1.8 volumes of nitrogen per unit volume of the liquid product.

31. The container defined in claim 30 containing 0.8-1.2 volumes of nitrogen per unit volume of the liquid product.

32. The container defined in claim 31 containing 1 -1.2 volumes of nitrogen per unit volume of the liquid product.

33. The container defined in claim 26 containing 0.01-3.5 volumes of nitrous oxide per unit volume of the liquid product.

34. The container defined in claim 33 containing 0.4-1.2 volumes of nitrous oxide per unit volume of the liquid product.

35. A method of producing a carbonated liquid product, such as beer, packed in cans or bottles or other suitable containers which includes:
(i) placing a predetermined quantity of a carbonated liquid product in the cans or bottles or other suitable containers;
(ii) adding nitrogen and nitrous oxide, and optionally one or more other additives which promote foaming, to the liquid product in the cans or bottles or other suitable containers; and
(iii) sealing the cans or bottles or other suitable container.

36. The method defined in claim 35 wherein the nitrogen is added as liquid nitrogen.

37. The method defined in claim 35 wherein, when nitrogen and carbon dioxide are the only foaming agents in the liquid product, the nitrogen is added in step (ii) in an amount of more than 1.14 grams of nitrogen per liter of the liquid product.

38. A method of producing a carbonated liquid product, su ch as beer, packed in cans or bottles or other suitable containers, which includes:
(i) dissolving nitrogen and nitrous oxide, and optionally one or more other additives which promote foaming, into a carbonated liquid product to form a nitrogen-containing liquid product;
(ii) partially filling a can or bottles or other suitable container with a predetermined quantity of the nitrogen-containing liquid product; and
(iii) sealing the can or bottle or other suitable container.

39. The method defined in claim 38 wherein the nitrogen is added as a gas.

40. The method defined in claim 38 wherein when nitrogen and carbon dioxide are the only foaming agents in the liquid product, the nitrogen is added in step (ii) in an amount of more than 1.14 grams of nitrogen per liter of the liquid product.

41. The method defined in claim 38 wherein the method includes chilling the carbonated liquid product prior to dissolving nitrogen in step (i).

42. The method defined in claim 38 further including the step of adding liquid nitrogen to the head space of the partially filled can or bottle or other suitable container prior to sealing the can or bottle or other suitable container.
